(19) United States
(12) Patent Application Publication
(10) Pub. No.: US 2025/0350047 A1
(43) Pub. Date: Nov. 13, 2025

(54) Terminal Carrier and Connector Assembly Device

(71) Applicant: Tyco Electronics (Shanghai) Co., Ltd., Shanghai (CN)

(72) Inventors: Junqiang Wang, Suzhou (CN); Ying Yin, Shanghai (CN)

(73) Assignee: Tyco Electronics (Shanghai) Co., Ltd., Shanghai (CN)

(21) Appl. No.: 19/203,906

(22) Filed: May 9, 2025

(30) Foreign Application Priority Data
May 11, 2024 (CN) 202410587328.1

(51) Int. Cl. H01R 12/61; H01R 43/20

(52) U.S. Cl. CPC H01R 12/61; H01R 43/20

(57) ABSTRACT

A terminal carrier comprises a fixture and a moving component. The fixture is adapted to clamp an electrical connection member connected to a terminal. The moving component is mounted on the fixture in a movable manner and can be moved relative to the fixture between an initial position and a final position along a longitudinal direction. A guide groove adapted to mate with the terminal is formed on the moving component, and positions and guides the terminal to be inserted into a housing along the longitudinal direction. When the moving component is in the initial position, the terminal is positioned in the guide groove. As the moving component is moved from the initial position to the final position, the terminal gradually extends from the guide groove to allow the terminal to be gradually inserted into the housing.

### CROSS-REFERENCE TO RELATED APPLICATION

This application claims the priority benefit of Chinese Patent Application No. CN202410587328.1 filed on May 11, 2024 in the State Intellectual Property Office of China, the whole disclosure of which is incorporated herein by reference.

### FIELD OF THE DISCLOSURE

The present disclosure relates to a terminal carrier and a connector assembly device comprising the terminal carrier.

### BACKGROUND

In the prior art, when assembling a connector with a Flexible Printed Circuit (FPC) or a Flexible Flat Cable (FFC), the terminals that are crimped onto the FPC or FFC are usually manually inserted into the sockets in the housing one by one. During the process of terminal insertion, each terminal on the flexible printed circuit or flexible flat cable needs to be aligned with the corresponding socket in the housing, and the insertion force and depth of the terminal need to be controlled by feeling. The current manual terminal insertion solution has problems of low efficiency, poor accuracy, and high scrap rate.

### SUMMARY

According to an embodiment of the present disclosure, a terminal carrier comprises a fixture and a moving component. The fixture is adapted to clamp an electrical connection member connected to a terminal. The moving component is mounted on the fixture in a movable manner and can be moved relative to the fixture between an initial position and a final position along a longitudinal direction. A guide groove adapted to mate with the terminal is formed on the moving component, and positions and guides the terminal to be inserted into a housing along the longitudinal direction. When the moving component is in the initial position, the terminal is positioned in the guide groove. As the moving component is moved from the initial position to the final position, the terminal gradually extends from the guide groove to allow the terminal to be gradually inserted into the housing.

### BRIEF DESCRIPTION OF THE DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a terminal carrier according to an exemplary embodiment of the present invention, in which the moving component is in an initial position relative to the fixture;

FIG. 2 shows an illustrative perspective view of a terminal carrier according to an exemplary embodiment of the present invention, in which the moving component is moved backwards relative to the fixture to the final position;

FIG. 3 shows an illustrative perspective view of a terminal carrier and housing according to an exemplary embodiment of the present invention, with the moving component in the initial position;

FIG. 4 shows an illustrative perspective view of a terminal carrier and a housing according to an exemplary embodiment of the present invention, in which the moving component is in the initial position and the front end of the terminal is pre inserted into the housing;

FIG. 5 shows an illustrative perspective view of a terminal carrier and a housing according to an exemplary embodiment of the present invention, in which the moving component is pushed to the final position by the housing carrier, causing the terminal to be inserted into the housing;

FIG. 6 shows an illustrative exploded view of a terminal carrier according to an exemplary embodiment of the present invention when viewed from the top, with the moving component in the initial position;

FIG. 7 shows another illustrative exploded view of a terminal carrier according to an exemplary embodiment of the present invention when viewed from the top, with the moving component in the initial position;

FIG. 8 shows an illustrative exploded view of a terminal carrier according to an exemplary embodiment of the present invention when viewed from the bottom, with the moving component in the initial position;

FIG. 9 shows an illustrative perspective view of a housing carrier according to an exemplary embodiment of the present invention, in which the housing has been placed in the positioning slot of the positioning seat;

FIG. 10 shows an illustrative perspective view of a housing carrier according to an exemplary embodiment of the present invention, wherein the housing has not yet been placed into the positioning slot of the positioning seat;

FIG. 11 shows a longitudinal sectional view of a housing carrier according to an exemplary embodiment of the present invention, wherein the housing has been placed into the positioning slot of the positioning seat;

FIG. 12 shows a side view of a housing and terminals according to an exemplary embodiment of the present invention, where the terminals have not yet been inserted into the housing;

FIG. 13 shows a side view of a housing and terminals according to an exemplary embodiment of the present invention, wherein the terminal has been inserted into a predetermined installation position in the housing;

FIG. 14 shows a side view of a housing and terminals according to an exemplary embodiment of the present invention, where the terminals are not inserted into the predetermined installation position in the housing;

FIG. 15 shows a plan sectional view of a connector and probes according to an exemplary embodiment of the present invention, where the probe has not yet been inserted into the housing;

FIG. 16 shows a plan sectional view of a connector and probes according to an exemplary embodiment of the present invention, wherein the probe has been inserted into the housing to a predetermined depth and is in electrical contact with the front end of the terminal in the housing; and

FIG. 17 shows a plan sectional view of a connector and probes according to an exemplary embodiment of the present invention, wherein the probe has been inserted into the housing to a predetermined depth and is not in contact with the front end of the terminal in the housing.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a terminal carrier comprises: a fixture used to clamp an electrical connection member connected to a terminal; and a moving component which is mounted on the fixture in a movable manner and can be moved relative to the fixture between an initial position and a final position along a longitudinal direction. A guide groove suitable for mating with the terminal is formed on the moving component. The guide groove is used to position and guide the terminal to be inserted into a housing along the longitudinal direction. When the moving component is in the initial position, the terminal is positioned in the guide groove. As the moving component is moved from the initial position to the final position, the terminal gradually extends from the guide groove to allow the terminal to be gradually inserted into the housing.

According to another embodiment of the present disclosure, a connector assembly device comprises the above terminal carrier used for loading terminals, a housing carrier used for loading a housing, and a driving device for driving the housing carrier to move along the longitudinal direction. The guide groove on the moving component is aligned with the socket in the housing along the longitudinal direction to guide the terminal to be inserted into the socket of the housing along the longitudinal direction. As the moving component is pushed from the initial position to the final position by the housing carrier, the terminal gradually extends from the guide groove of the moving component and is gradually inserted into the housing.

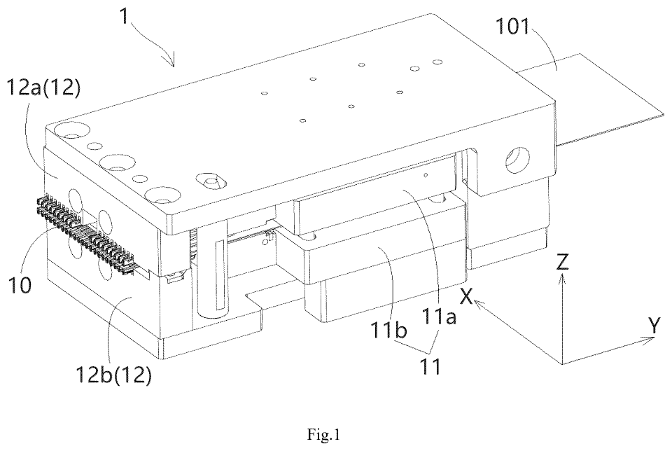

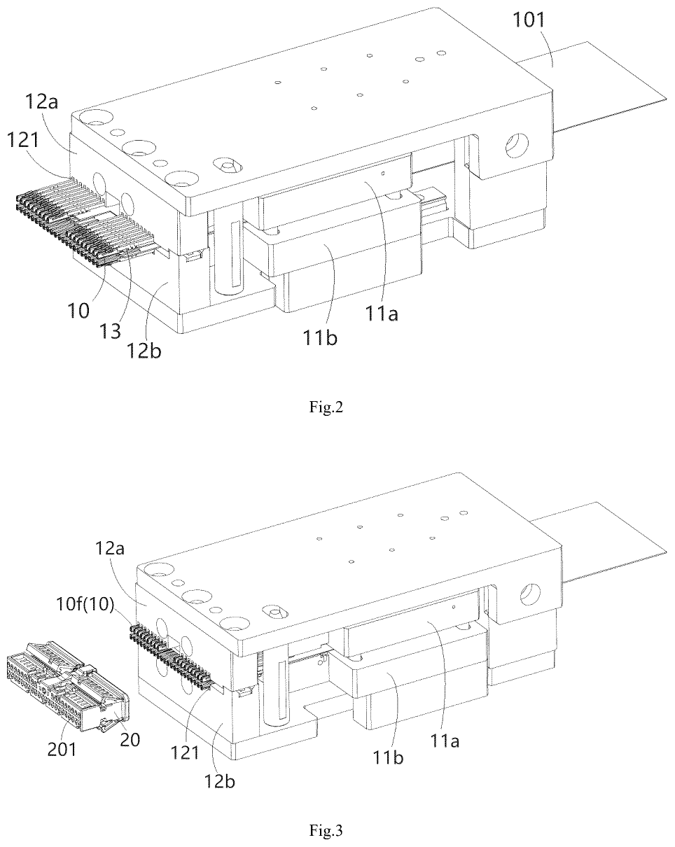

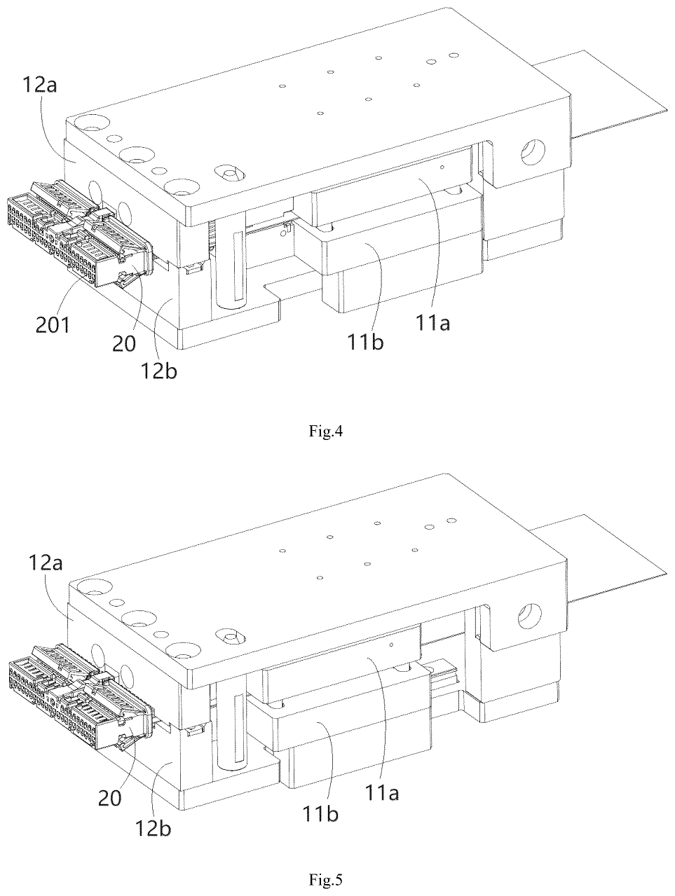

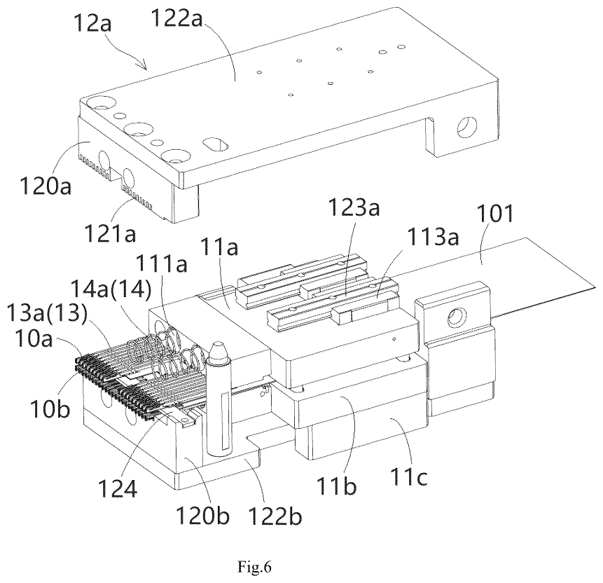

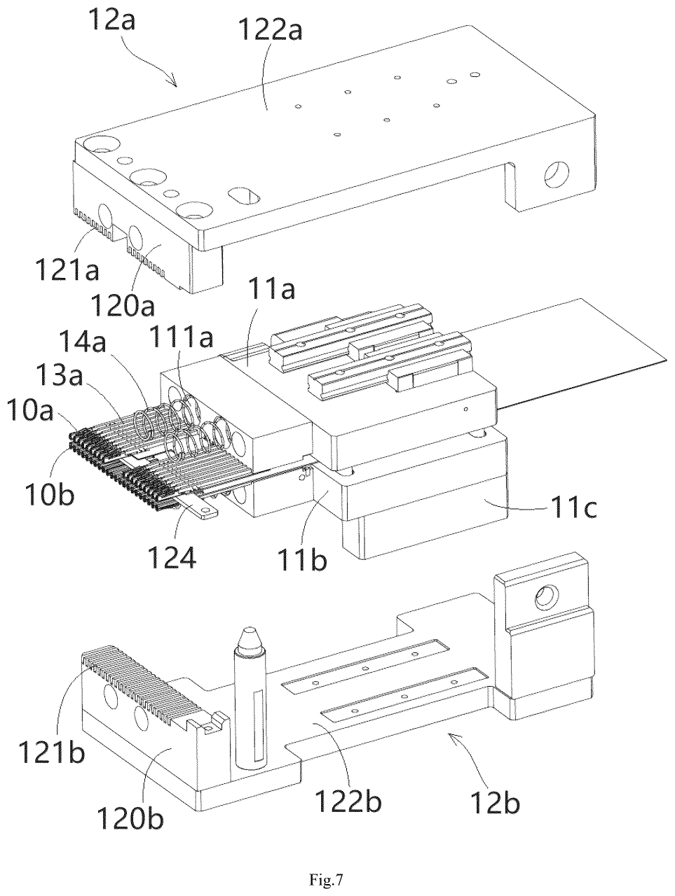

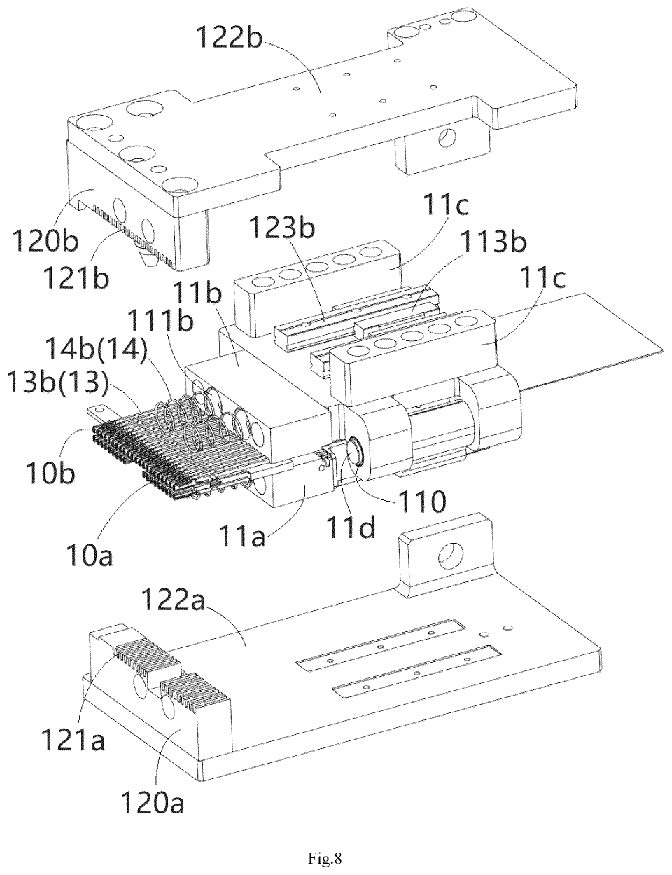

FIG. 1 shows an illustrative perspective view of a terminal carrier 1 according to an exemplary embodiment of the present invention, in which the moving component 12 is in the initial position relative to the fixture 11. FIG. 2 shows an illustrative perspective view of a terminal carrier 1 according to an exemplary embodiment of the present invention, in which the moving component 12 is moved backwards relative to the fixture 11 to the final position. FIG. 3 shows an illustrative perspective view of the terminal carrier 1 and the housing 20 according to an exemplary embodiment of the present invention, with the moving component 12 in the initial position. FIG. 4 shows an illustrative perspective view of a terminal carrier 1 and a housing 20 according to an exemplary embodiment of the present invention, in which the moving component 12 is in the initial position and the front end 10f of the terminal 10 is pre inserted into the housing 20. FIG. 5 shows an illustrative perspective view of a terminal carrier 1 and a housing 20 according to an exemplary embodiment of the present invention, in which the moving component 12 is pushed to the final position by the housing carrier 2, causing the terminal 10 to be inserted into the housing 20. FIG. 6 shows an illustrative exploded view of the terminal carrier 1 according to an exemplary embodiment of the present invention when viewed from the top, with the moving component 12 in the initial position. FIG. 7 shows another illustrative exploded view of the terminal carrier 1 according to an exemplary embodiment of the present invention when viewed from the top, with the moving component 12 in the initial position. FIG. 8 shows an illustrative exploded view of the terminal carrier 1 according to an exemplary embodiment of the present invention when viewed from the bottom, with the moving component 12 in the initial position.

As shown in FIGS. 1-8, in an exemplary embodiment of the present invention, a terminal carrier 1 is disclosed. The terminal carrier 1 includes a fixture 11 and a moving component 12. The fixture 11 is used to clamp the electrical connection member 101 connected to the terminal 10. The electrical connection member 101 can be a wire harness or a circuit board used for transmitting electrical signals. The moving component 12 is mounted on the fixture 11 in a movable manner, and can be moved relative to the fixture 11 along the longitudinal direction Y between an initial position (position shown in FIG. 1) and a final position (position shown in FIG. 2). A guide groove 121 is formed on the moving component 12, which is suitable for mating with the terminal 10. The guide groove 121 is used to position and guide the terminal 10 to be inserted into the housing 20 along the longitudinal direction Y. When the moving component 12 is in its initial position, the terminal 10 is positioned in the guide slot 121. When the moving component 12 is moved from the initial position to the final position, the terminal 10 gradually extends from the guide groove 121 to allow the terminal 10 to be gradually inserted into the housing 20.

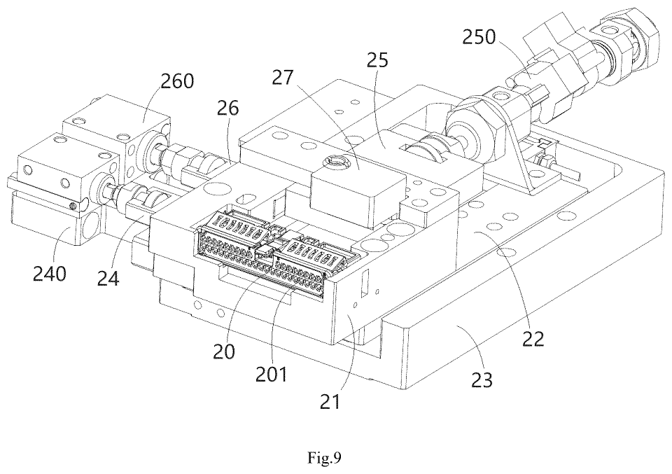

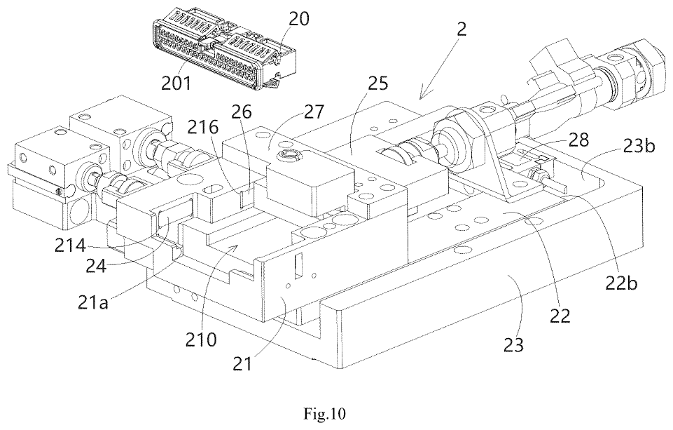

In the illustrated embodiment, the moving component 12 is adapted to move along the longitudinal direction Y from the initial position towards the rear to the final position under the push of the housing carrier 2 (see FIGS. 9 and 10) loaded with the housing 20.

The electrical connection member 101 is a flexible printed circuit or a flexible flat cable. The terminal carrier 1 also includes a push pin 13, which is adapted to rest on the step portion 10c of the terminal 10 along the longitudinal direction Y to ensure that the terminal 10 does not move backward during the process of being inserted forward into the housing 20. Of note, when the electrical connection member 101 is a hard cable or a hard circuit board, the push pin 13 is not needed.

The fixture 11 includes an upper clamping block 11a and a lower clamping block 11b that are opposite in the height direction Z. The upper clamping block 11a and lower clamping block 11b have opposite ends in the longitudinal direction Y and opposite sides in the transverse direction X. One side of the upper clamping block 11a and one side of the lower clamping block 11b are rotatably connected, so that the upper clamping block 11a can be rotated relative to the lower clamping block 11b between a closed position of clamping the electrical connection member 101 and an open position of releasing the electrical connection member 101. Mounting holes 110 are respectively formed in one side of the upper clamping block 11a and one side of the lower clamping block 11b. The upper clamping block 11a and the lower clamping block 11b are rotatably connected together through a pivot shaft 11d inserted into the mounting holes 110.

The moving component 12 includes an upper moving component 12a and a lower moving component 12b. The upper moving component 12a is fixedly mounted on the upper clamping block 11a and can be rotated together with the upper clamping block 11a, while the lower moving component 12b is fixedly mounted on the lower clamping block 11b; The guide groove 121 includes an upper row of guide grooves 121a formed on the upper moving component 12a and a lower row of guide grooves 121b formed on the lower moving component 12b. The push pin 13 includes an upper row of push pins 13a mounted on the upper clamping block 11a and a lower row of push pins 13b mounted on the lower clamping block 11b. The upper row of guide grooves 121a and the lower row of guide grooves 121b are used to locate and guide the upper row of terminals 10a and the lower row of terminals 10b, respectively. The upper row of pins 13a and the lower row of pins 13b are respectively used to rest against the step portions 10c of the upper row of terminals 10a and the lower row of terminals 10b, so that the upper row of terminals 10a and the lower row of terminals 10b can be inserted into the housing 20 simultaneously.

When the upper clamping block 11a is rotated to the closed position, the upper moving component 12a is rotated to an assembly position engaged with the lower moving component 12b. This ensures that the upper moving component 12a and the lower moving component 12b can be moved synchronously along the longitudinal direction Y.

The upper moving component 12a includes an upper mounting plate 122a and an upper seat body 120a. The upper mounting plate 122a is mounted on top of the upper clamping block 11a in a movable manner. The front end of the upper seat body 120a is connected to the upper mounting plate 122a and formed with the upper row of guide grooves 121a. The lower moving component 12b includes a lower mounting plate 122b and a lower seat body 120b. The lower mounting plate 122b is mounted on the bottom of the lower clamping block 11b in a movable manner. The lower seat body 120b is connected to the front end 10f of the lower mounting plate 122b and formed with the lower row of guide grooves 121b.

An upper slide rail 123a extending along the longitudinal direction Y is fixed on one of the upper mounting plate 122a and the upper clamping block 11a, and an upper slider 113a is fixed on the other, which is slidably engaged with the upper slide rail 123a. A lower slide rail 123b extending along the longitudinal direction Y is fixed on one of the lower mounting plate 122b and the lower clamping block 11b, and a lower slider 113b is fixed on the other, which is slidably engaged with the lower slide rail 123b.

The moving component 12 further comprises a partition plate 124, which extends along the transverse direction X and is fixed to the upper seat body 120a or the lower seat body 120b. The partition plate 124 is inserted between the upper row of terminals 10a and the lower row of terminals 10b to ensure that the spacing between the upper row of terminals 10a and the lower row of terminals 10b is equal to a predetermined spacing.

The terminal carrier 1 further comprises a reset spring 14, which is compressed along the longitudinal direction Y between the fixture 11 and the moving component 12, for resetting the moving component 12 from the final position to the initial position.

The reset spring 14 includes an upper reset spring 14a and a lower reset spring 14b. The upper reset spring 14a is compressed along the longitudinal direction Y between the upper clamping block 11a and the upper seat body 120a. The lower reset spring 14b is compressed along the longitudinal direction Y between the lower clamping block 11b and the lower seat body 120b. An upper positioning hole 11a is formed in the upper clamping block 11a, and one end of the upper reset spring 14a is accommodated in the upper positioning hole 11a, while the other end is pressed against the rear side of the upper seat body 120a. A lower positioning hole 111b is formed in the lower clamping block 11b, and one end of the lower reset spring 14b is accommodated in the lower positioning hole 111b, while the other end is pressed against the rear side of the lower seat body 120b.

The terminal carrier 1 further comprises a fixed seat for fixing the lower clamping block 11b and adapted to be fixed to a frame. Vertical fixing parts 11c are respectively connected on both sides of the lower clamping block 11b and are fixed to the fixed seat. The lower moving component 12b is suspended above the fixed seat by the fixing parts 11c, so as not to affect the movement of the lower moving component 12b.

When the moving component 12 is in the initial position, the terminal 10 is positioned in the guide groove 121 and its front end 10f extends from the guide groove 121 to allow the front end 10f of the terminal 10 to be pre inserted into the housing 20.

FIG. 9 shows an illustrative perspective view of a housing carrier 2 according to an exemplary embodiment of the present invention, in which the housing 20 has been placed into the positioning slot 210 of the positioning seat 21. FIG. 10 shows an illustrative perspective view of a housing carrier 2 according to an exemplary embodiment of the present invention, where the housing 20 has not yet been placed into the positioning slot 210 of the positioning seat 21. FIG. 11 shows a longitudinal sectional view of a housing carrier 2 according to an exemplary embodiment of the present invention, wherein the housing 20 has been placed into the positioning slot 210 of the positioning seat 21.

As shown in FIGS. 1-11, in another exemplary embodiment of the present disclosure, a connector assembly device is also disclosed. The connector assembly device includes: a terminal carrier 1, a housing carrier 2, and a driving device (not shown). The terminal carrier 1 is used to load terminals 10. The housing carrier 2 is used to load a housing 20. The driving device (not shown) is used to drive the housing carrier 2 to move along the longitudinal direction Y. The driving device can be a linear electric cylinder. The guide groove 121 on the moving component 12 is aligned with the socket 201 in the housing 20 in the longitudinal direction Y to guide the terminal 10 to be inserted into the socket 201 of the housing 20 along the longitudinal direction Y. When the moving component 12 is pushed from the initial position to the final position by the housing carrier 2, the terminal 10 gradually extends from the guide groove 121 of the moving component 12 and is gradually inserted into the housing 20.

The housing carrier 2 includes a positioning seat 21, a first pushing member 24, and a first driver 240. A positioning slot 210 that is mated with the housing 20 is formed in the positioning seat 21, and a slot hole 214 that communicates with the positioning slot 210 is formed in one side wall of the positioning seat 21. The first pushing member 24 is installed in the slot hole 214 in a movable manner and can be moved along the transverse direction X perpendicular to the longitudinal direction Y. The first driver 240 is installed on one side of the positioning seat 21 and connected to the first pushing member 24, used to drive the first pushing member 24 to move in the transverse direction X. The first driver 240 can be a cylinder. The first pushing member 24 is used to push the housing 20 along the transverse direction X, so that the housing 20 is clamped and fixed between the first pushing member 24 and the other side wall of the positioning seat 21 in the transverse direction X.

The positioning slot 210 has a front opening and a rear opening that are opposite in the longitudinal direction Y. A positioning step 21a is formed on the inner side of the front opening of the positioning slot 210, which is suitable for resting against the peripheral portion of the front end face of the housing 20 along the longitudinal direction Y. The housing carrier 2 also includes a second pushing member 25 and a second driver 250. The second pushing member 25 is installed in the rear opening of the positioning slot 210 in a movable manner and can be moved along the longitudinal direction Y. The second driver 250 is installed on the rear side of the positioning seat 21 and connected to the second pushing member 25, used to drive the second pushing member 25 to move along the longitudinal direction Y. The second driver 250 can be a cylinder. The second pushing member 25 is used to push the housing 20 along the longitudinal direction Y, so that the housing 20 is clamped and fixed between the second pushing member 25 and the positioning step 21a of the positioning seat 21 in the longitudinal direction Y.

The positioning slot 210 has a bottom wall and a top opening that are opposite in the height direction Z. The housing carrier 2 also includes a top plate 27, a post 271, a sphere 272, and an elastic component 273. The top plate 27 is fixed to the top of the second pushing member 25 and formed with a vertical through-hole. The post 271 is fixedly inserted into the vertical through-hole of the top plate 27 and formed with a blind hole 270 with an open lower end. The sphere 272 is installed in the blind hole 270 and partially protrudes from the opening of the blind hole 270. The elastic component 273 is compressed between the top wall of the blind hole 270 and the sphere 272, used to apply a vertical pressing force to the sphere 272. In order to prevent the sphere 272 from falling out of the opening of the blind hole 270, the opening size of the blind hole 270 is slightly smaller than the diameter of the sphere 272. The sphere 272 is used to press the housing 20 downwards along the height direction Z, so that the housing 20 is clamped and fixed between the sphere 272 and the bottom wall of the positioning slot 210 in the height direction Z.

A first pin hole 216 extending along the transverse direction X is formed in the positioning seat 21, and a second pin hole (not shown) is formed in the second pushing member 25. The housing carrier 2 also includes a locking pin 26 and a third driver 260. The locking pin 26 is installed in the first pin hole 216 in a movable manner. The third driver 260 is installed on one side of the positioning seat 21 and connected to the locking pin 26, used to drive the locking pin 26 to move along the transverse direction X. The third driver 260 can be a cylinder. When the second pushing member 25 is moved to a predetermined position of clamping and fixing the housing 20 in the longitudinal direction Y, the first pin hole 216 and the second pin hole are aligned in the transverse direction X, and the locking pin 26 is inserted into the second pin hole to lock the second pushing member 25 in the predetermined position.

The housing carrier 2 further comprises a base plate 22, a bottom seat 23, and a force sensor 28. The positioning seat 21 is fixed on the base plate 22. The base plate 22 is mounted on the bottom seat 23 in a movable manner and has a rear side wall 23b opposite to the rear side surface 22b of the base plate 22. The force sensor 28 is clamped between the rear side surface 22b of the base plate 22 and the rear side wall 23b of the bottom seat 23, for detecting the insertion force of the terminal 10 into the housing 20. The force sensor 28 may include a varistor. The aforementioned driving device is connected to the bottom seat 23, used to drive the housing carrier 2 to move along the longitudinal direction Y, and the driving device stops driving the housing carrier 2 when the insertion force detected by the force sensor 28 is greater than the predetermined insertion force.

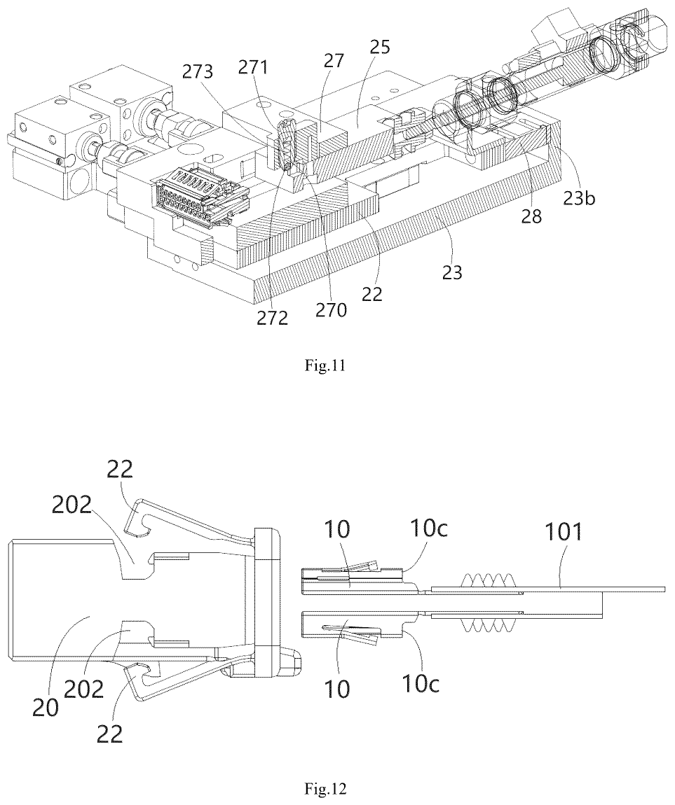

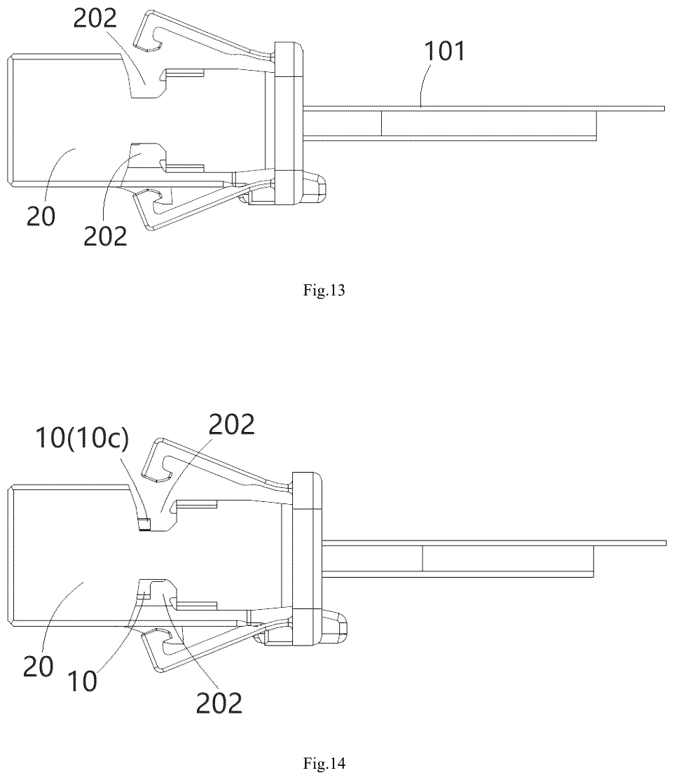

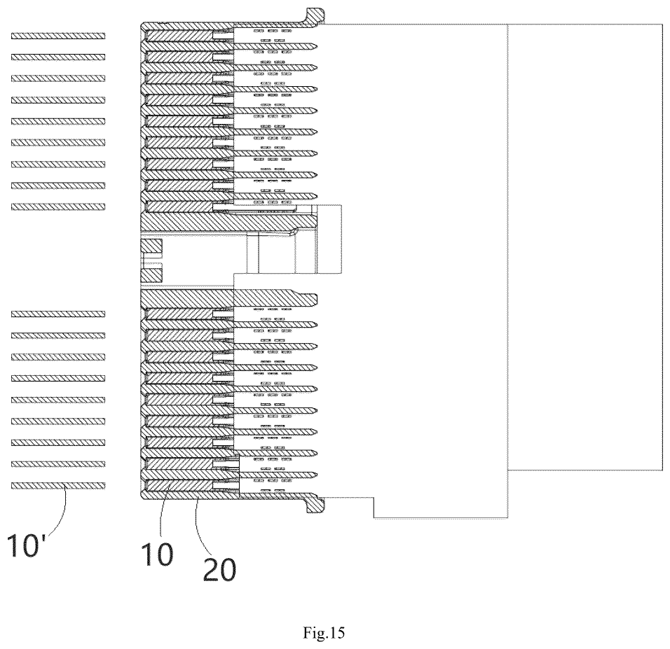

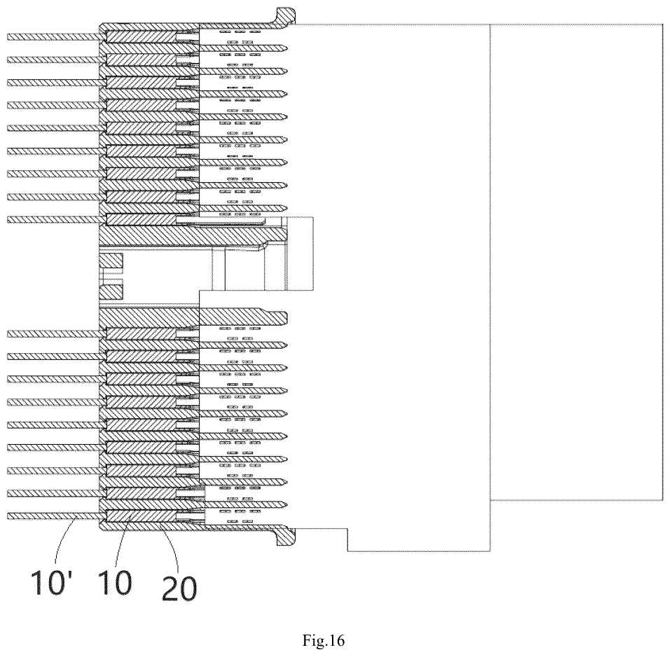

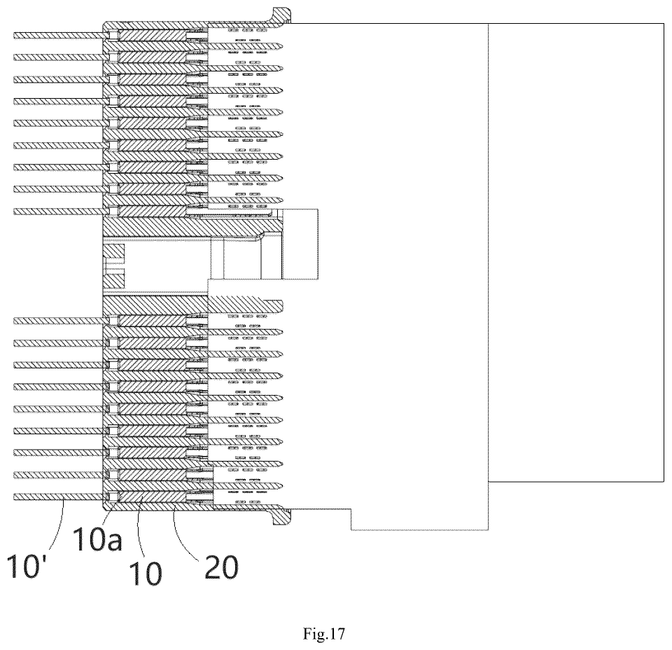

FIG. 12 shows a side view of the housing 20 and terminal 10 according to an exemplary embodiment of the present invention, where terminal 10 has not yet been inserted into the housing 20. FIG. 13 shows a side view of a housing 20 and a terminal 10 according to an exemplary embodiment of the present invention, wherein the terminal 10 has been inserted into a predetermined installation position in the housing 20. FIG. 14 shows a side view of the housing 20 and terminal 10 according to an exemplary embodiment of the present invention, where terminal 10 is not inserted into the predetermined installation position in the housing 20. FIG. 15 shows a plan sectional view of a connector and probe 10′ according to an exemplary embodiment of the present invention, where the probe 10′ has not yet been inserted into the housing 20. FIG. 16 shows a plan sectional view of a connector and probe 10′ according to an exemplary embodiment of the present invention, wherein the probe 10′ has been inserted into the housing 20 to a predetermined depth and is in electrical contact with the front end 10f of the terminal 10 in the housing 20. FIG. 17 shows a plan sectional view of a connector and probe 10′ according to an exemplary embodiment of the present invention, wherein the probe 10′ has been inserted into the housing 20 to a predetermined depth and is not in contact with the front end 10f of the terminal 10 in the housing 20.

As shown in FIGS. 1-17, in the illustrated embodiment, the connector assembly device further includes a detection device for detecting whether the terminal 10 has been inserted into a predetermined installation position in the housing 20.

More specifically, as shown in FIGS. 12-14, the detection device includes a visual detection device (not shown), which may include a camera for capturing an image of a secondary lock slot 202 of the housing 20 from one lateral side of the housing 20 and determining whether the terminal 10 has been inserted into the predetermined installation position based on the captured image of the secondary lock slot 202. As shown in FIG. 13, when terminal 10 cannot be seen in the captured image of the secondary lock slot 202, the visual detection device determines that terminal 10 has been inserted into the predetermined installation position. As shown in FIG. 14, when the terminal 10 is seen in the captured image of the secondary lock slot 202, the visual detection device determines that the terminal 10 has not been inserted into the predetermined installation position. For example, in FIG. 14, the step portion 10c of the terminal 10 can be seen in the secondary lock slot 202. Therefore, the visual detection device will determine that the terminal 10 has not been inserted into the predetermined installation position.

As shown in FIGS. 15-17, in the illustrated embodiment, the detection device further comprises a probe detection device. The probe detection device includes a probe 10′ and a detection circuit. The probe 10′ is suitable for insertion into the housing 20 at a predetermined depth position. The detection circuit is electrically connected to probe 10′ and the terminal 10.

As shown in FIG. 16, when the probe 10′ is inserted into the housing 20 at a predetermined depth position and the probe 10′ is in electrical contact with the front end 10f of the terminal 10, the detection circuit is in on, and the probe detection device determines that the terminal 10 has been inserted into the predetermined installation position.

As shown in FIG. 17, when the probe 10′ is inserted into the predetermined depth position in the housing 20 and the probe 10′ is not in contact with the front end 10f of the terminal 10, the detection circuit is in off, and the probe detection device determines that the terminal 10 has not been inserted into the predetermined installation position.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A terminal carrier, comprising:
a fixture used to clamp an electrical connection member connected to a terminal; and
a moving component mounted on the fixture in a movable manner and movable relative to the fixture between an initial position and a final position along a longitudinal direction, a guide groove adapted to mate with the terminal is formed on the moving component, and positions and guides the terminal to be inserted into a housing along the longitudinal direction, wherein:
when the moving component is in the initial position, the terminal is positioned in the guide groove; and
as the moving component is moved from the initial position to the final position, the terminal extends from the guide groove to allow the terminal to be inserted into the housing.

2. The terminal carrier according to claim 1, wherein the moving component is adapted to be moved backwards along the longitudinal direction from the initial position to the final position under a bias of a housing carrier loaded with the housing.

3. The terminal carrier according to claim 1, wherein the electrical connection member is a flexible printed circuit or a flexible flat cable, and the terminal carrier further comprises a push pin adapted to rest on a step portion of the terminal along the longitudinal direction to ensure that the terminal cannot be moved backwards during insertion into the housing.

4. The terminal carrier according to claim 3, wherein:
the fixture comprises an upper clamping block and a lower clamping block that are opposite in a height direction, the upper clamping block and the lower clamping block have opposite ends in the longitudinal direction and opposite sides in a transverse direction;
one side of the upper clamping block and one side of the lower clamping block are rotatably connected such that the upper clamping block to be rotated relative to the lower clamping block between a closed position for clamping the electrical connection member and an open position for releasing the electrical connection member.

5. The terminal carrier according to claim 4, wherein installation holes are respectively formed in one side of the upper clamping block and one side of the lower clamping block, and the upper clamping block and the lower clamping block are rotatably connected through a pivot shaft inserted into the installation holes.

6. The terminal carrier according to claim 4, wherein:
the moving component includes an upper moving component and a lower moving component, the upper moving component is fixedly mounted on the upper clamping block and can be rotated together with the upper clamping block, and the lower moving component is fixedly mounted on the lower clamping block;
the guide groove comprises an upper row of guide grooves formed on the upper moving component and a lower row of guide grooves formed on the lower moving component, and the push pin comprises an upper row of push pins mounted on the upper clamping block and a lower row of push pins mounted on the lower clamping block;
the upper row of guide grooves and the lower row of guide grooves are respectively used to locate and guide the upper row of terminals and the lower row of terminal, the upper row of push pins and the lower row of push pins are respectively used to rest on the step portions of the upper row of terminals and the lower row of terminals, so that the upper row of terminals and the lower row of terminals can be simultaneously inserted into the housing.

7. The terminal carrier according to claim 6, wherein when the upper clamping block is rotated to the closed position, the upper moving component is rotated to an assembly position engaged with the lower moving component to ensure that the upper moving component and the lower moving component can be moved synchronously along the longitudinal direction.

8. The terminal carrier according to claim 7, wherein:
the upper moving component comprises:
an upper mounting plate mounted on top of the upper clamping block in a movable manner; and
an upper seat body connected to the front end of the upper mounting plate and formed with the upper row of guide grooves; and
the lower moving component comprises:
a lower mounting plate mounted on the bottom of the lower clamping block in a movable manner; and
a lower seat body connected to the front end of the lower mounting plate and formed with the lower row of guide grooves.

9. The terminal carrier according to claim 8, wherein:
an upper slide rail extending along the longitudinal direction is fixed on one of the upper mounting plate and the upper clamping block, and an upper slider is fixed on the other, which is slidably engaged with the upper slide rail; and
a lower slide rail extending along the longitudinal direction is fixed on one of the lower mounting plate and the lower clamping block, and a lower slider is fixed on the other, which is slidably engaged with the lower slide rail.

10. The terminal carrier according to claim 8, wherein the moving component further comprises a partition plate extending along the transverse direction and fixed to the upper seat body or the lower seat body, the partition plate is inserted between the upper row of terminals and the lower row of terminals to ensure that the spacing between the upper row of terminals and the lower row of terminals is equal to a predetermined spacing.

11. The terminal carrier according to claim 8, further comprising a reset spring which is compressed along the longitudinal direction between the fixture and the moving component, the resent spring adapted to reset the moving component from the final position to the initial position.

12. The terminal carrier according to claim 11, wherein the reset spring comprises:
an upper reset spring compressed along the longitudinal direction between the upper clamping block and the upper seat body; and
a lower reset spring compressed along the longitudinal direction between the lower clamping block and the lower seat body, wherein:
an upper positioning hole is formed in the upper clamping block, and one end of the upper reset spring is accommodated in the upper positioning hole and another end is pressed against the rear side of the upper seat body; and
a lower positioning hole is formed in the lower clamping block, and one end of the lower reset spring is accommodated in the lower positioning hole and another end is pressed against the rear side of the lower seat body.

13. The terminal carrier according to claim 6, further comprising a fixed seat for fixing the lower clamping block, wherein vertical fixing parts are respectively connected on both sides of the lower clamping block, and the vertical fixing parts are fixed to the fixed seat, the lower moving component is suspended above the fixed seat by the fixing parts.

14. The terminal carrier according to claim 1, wherein when the moving component is in the initial position, the terminal is positioned in the guide groove and its front end extends from the guide groove to allow the front end of the terminal to be pre inserted into the housing.

15. A connector assembly device, comprising:
the terminal carrier according to claim 1 adapted to load terminals;
a housing carrier adapted to load a housing; and
a driving device driving the housing carrier to move along the longitudinal direction, wherein the guide groove on the moving component is aligned with the socket in the housing along the longitudinal direction to guide the terminal to be inserted into the socket of the housing along the longitudinal direction, during the moving component is pushed from the initial position to the final position by the housing carrier, the terminal extends from the guide groove of the moving component and is inserted into the housing.

16. The connector assembly device according to claim 15, wherein the housing carrier comprises:
a positioning seat formed with a positioning slot for mating with the housing, wherein a slot hole communicated with the positioning slot is formed in one side wall of the positioning seat;
a first pushing member installed in the slot hole in a movable manner and can be moved along the transverse direction perpendicular to the longitudinal direction; and
a first driver installed on one side of the positioning seat and connected to the first pushing member, used to drive the first pushing member to move along the transverse direction, wherein the first pushing member is used to push the housing along the transverse direction, so that the housing is clamped and fixed between the first pushing member and the other side wall of the positioning seat in the transverse direction.

17. The connector assembly device according to claim 16, wherein:
the positioning slot has a front opening and a rear opening that are opposite in the longitudinal direction, and a positioning step is formed on the inner side of the front opening of the positioning slot, which is adapted to rest on the peripheral part of the front end face of the housing along the longitudinal direction; and
the housing carrier further comprises:
a second pushing member movably installed in the rear opening of the positioning slot, and can be moved along the longitudinal direction; and
a second driver installed on the rear side of the positioning seat and connected to the second pushing member, used to drive the second pushing member to move along the longitudinal direction, the second pushing member is used to push the housing along the longitudinal direction, so that the housing is clamped and fixed between the second pushing member and the positioning step of the positioning seat in the longitudinal direction.

18. The connector assembly device according to claim 17, wherein:
the positioning slot has a bottom wall and a top opening that are opposite in the height direction; and
the housing carrier further comprises:
a top plate fixed to the top of the second pushing member and formed with a vertical through-hole;
a post fixedly inserted into the vertical through-hole of the top plate and formed a blind hole with an open lower end;
a sphere installed in the blind hole and partially protruding from the opening of the blind hole; and
an elastic component compressed between the top wall of the blind hole and the sphere and adapted to apply a vertical pressing force to the sphere, wherein the sphere is used to press the housing downwards along the height direction, so that the housing is clamped and fixed between the sphere and the bottom wall of the positioning slot in the height direction.

19. The connector assembly device according to claim 17, wherein:
a first pin hole extending along the transverse direction is formed in the positioning seat, and a second pin hole is formed in the second pushing member; and
the housing carrier further comprises:
a locking pin installed in the first pin hole in a movable manner; and
a third driver installed on one side of the positioning seat and connected to the locking pin and adapted to drive the locking pin to move along the transverse direction, when the second pushing member is moved to a predetermined position for clamping and fixing the housing in the longitudinal direction, the first pin hole and the second pin hole are aligned in the transverse direction and the locking pin is inserted into the second pin hole to lock the second pushing member in the predetermined position.

20. The connector assembly device according to claim 16, wherein the housing carrier further comprises:
a base plate on which the positioning seat is fixed;
a bottom seat on which the base plate is mounted in a movable manner, wherein the bottom seat has a rear side wall opposite to the rear side surface of the base plate; and
a force sensor clamped between the rear side surface of the base plate and the rear side wall of the bottom seat to detect the insertion force of the terminal into the housing, wherein the driving device is connected to the bottom seat for driving the housing carrier to move along the longitudinal direction, the driving device stops driving the housing carrier when the insertion force detected by the force sensor is greater than a predetermined insertion force.

21. The connector assembly device according to claim 16, further comprising a detection device adapted to detect whether the terminal has been inserted into a predetermined installation position in the housing.

22. The connector assembly device according to claim 21, wherein the detection device comprises a visual detection device adapted to capture an image of a secondary lock slot of the housing from one lateral side of the housing, and determining whether the terminal has been inserted into the predetermined installation position based on the captured image of the secondary lock slot, wherein:
when the terminal is not visible in the captured image of the secondary lock slot, the visual detection device determines that the terminal has been inserted into the predetermined installation position; and
when the terminal is seen in the captured image of the secondary lock slot, the visual detection device determines that the terminal has not been inserted into the predetermined installation position.

23. The connector assembly device according to claim 22, wherein the detection device further comprises a probe detection device, including:
a probe suitable for insertion into the housing at a predetermined depth position; and
a detection circuit electrically connected to the probe and the terminal, wherein:
when the probe is inserted into the predetermined depth position in the housing and the probe is in electrical contact with the front end of the terminal, the detection circuit is in on, and the probe detection device determines that the terminal has been inserted into the predetermined installation position; and
when the probe is inserted into the predetermined depth position of the housing and the probe is not in contact with the front end of the terminal, the detection circuit is in off, and the probe detection device determines that the terminal has not been inserted into the predetermined installation position.
